(19) United States
(12) Patent Application Publication
(10) Pub. No.: US 2016/0004247 A1
(43) Pub. Date: Jan. 7, 2016

(54) SYSTEM FOR PRODUCING COMPONENTS OF VARIOUS PRODUCT DESIGNS

(71) Applicant: KENNETH J. SUSNJARA, Birdseye, IN (US)

(72) Inventor: KENNETH J. SUSNJARA, Birdseye, IN (US)

(73) Assignee: Thermwood Corporation, Dale, IN (US)

(21) Appl. No.: 14/323,591

(22) Filed: Jul. 3, 2014

(51) Int. Cl. G05B 19/4097

(52) U.S. Cl. CPC G05B 19/4097; G05B 2219/35134; G05B 2219/37355

(57) ABSTRACT

A system comprising means mounted on a worktable of a machine for displacing a cutting tool along x, y and z axes, and a control computer programmed to store data relevant to the geometrical configuration of at least one product design and the components thereof, displaying a selected one product design, elicit alterations of such design, revise any such alterations and components thereof, nest the components of the selected design, device a cutting tool pattern for producing such components and operate servomotors to guide such cutting tool to form such components from a workpiece mounted on such worktable.

This invention relates to a system for producing the components of various product designs and more particularly to a system for readily producing the components of a selected product design by operators of comparatively low technical, computer and software skills.

### BACKGROUND OF THE INVENTION

In the manufacture of various products such as furniture including cabinets, dressers, bookcases and the like, the design of the product initially is developed and then the components of the designed product are designed, produced and assembled to provide the finished product. In the prior art, typically, in producing such a product, a skilled programmer utilizing a CAD system and a computer, would devise a program for a CNC machine to produce such components, such program would be inputted into the control system of a CNC machine and such programmed machine would be operated by a skilled operator to produce such components. Such process requires not only skilled personnel in developing such programs but skilled operators of programmed CNC machines for producing such components.

In view of the foregoing, the principal object of the present invention is to provide a system for producing the components of various product designs which may be operated by personal of comparatively low technical, computer and software skills, in effectively and competently producing such components.

Another object of the present invention is to provide a system operable to produce the components of a selected one of a number of product designs.

A further object of the present invention is to provide an integrated system operable to produce the components of a selected one of a number of product designs.

A still further object of the present invention is to provide a system for producing the components of a selected one of a number of product designs, operable by personnel engaged in cabinetmaking but inexperienced in and/or unknowledgable with respect to computers or computer software.

Another object of the present invention is to provide a system for producing the components of a number of product designs which would allow small business establishments with comparatively limited product designs and production capabilities to effectively compete with large business establishments with greater product designs and production capabilities, with respect to variety of product, price and delivery.

### SUMMARY OF THE INVENTION

The objects of the present invention are achieved by a system generally comprising a base structure; a worktable provided on such base structure; means mounted on such base structure, driven by servomotors for displacing a cutting tool in machining contact with a workpiece mounted on such worktable, along x, y and z-axes; and a control computer disposed integrally with such base structure, programmed to store data relevant to the geometrical configurations of at least one product design and the components thereof, display on command a selected one of such product designs, elicit verification or modification of such selected product design, revise the geometric configurations of the selected product design and the corresponding components thereof upon any modification input command, nest the components of the selected product design in final form, in an area commensurate with of a selected workpiece, devise a cutting tool path for producing the nested components from the selected workpiece positioned on the workable and operate the servomotors to guide the cutting tool along a tool path to produce the components of the selected product design from the workpiece positioned on the worktable.

In the preferred embodiment of the invention, the program of the control computer includes an algorithm functional to alter the magnitude of a selected product design responsive to an inputted designation command of a system operator, the program further includes an algorithm functional to alter the geometric configurations of a balance of the components of a selected product design upon selection and reconfiguration of a selected component of a selected product design, and the system still further includes a control screen operative to display a video indicating the manner required to produce components of a selected product design.

Additionally, features of the invention provide for suitably positioning a workpiece on a worktable, releasably securing a workpiece in a suitable position on the worktable, providing a touch screen for selecting displayed representations of selected product designs and the components thereof, and verifying or modifying the geometric configurations of either thereof, transferring a tool thereof to a change-over station on the worktable and indicating a replacement requirement of a cutting tool.

### BRIEF DESCRIPTION OF THE DRAWINGS

FIG. 1 is a flow diagram of the operation of the claimed system; and

FIG. 2 is a perspective view of a system embodying the present invention.

### DETAILED DESCRIPTION OF THE PREFERRED EMBODIMENT OF THE INVENTION

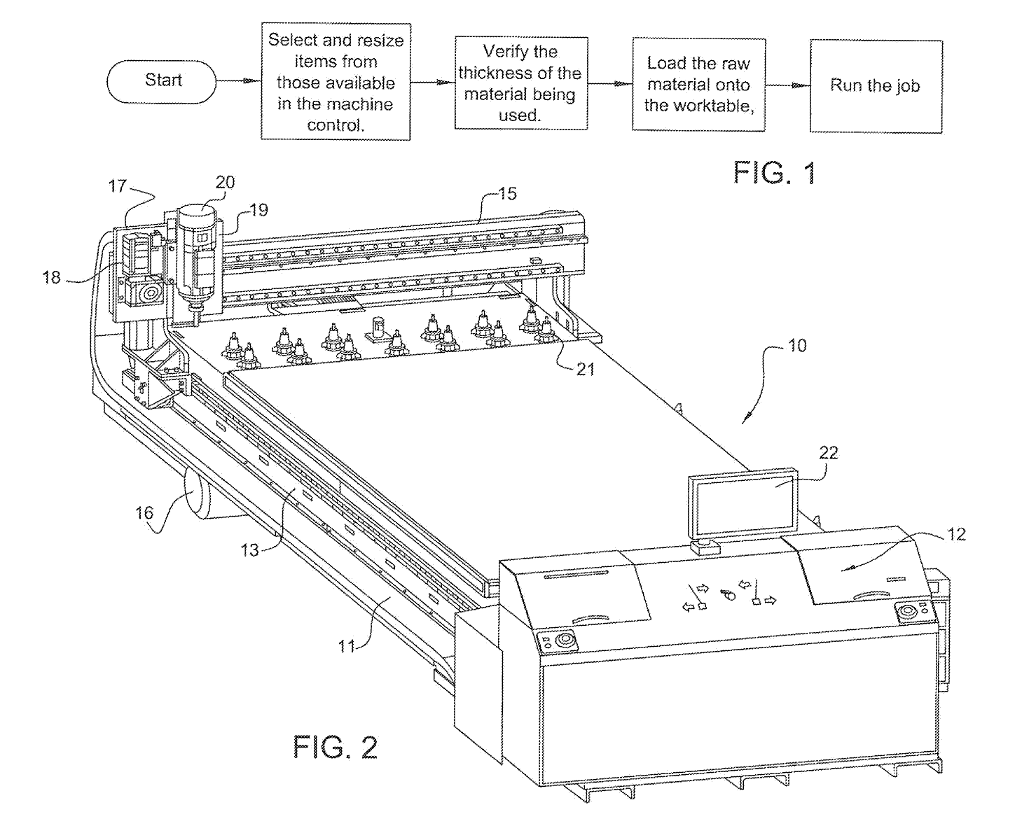

Referring to FIG. 1 of the drawings, there is illustrated a system 10 including a base structure 11 and an integral control computer 12 which embodies the present invention. The base structure generally includes a support structure 13 on which there is provided a worktable 14 and a gantry 15. Worktable 14 is formed of a porous material and overlies a recess in the upper surface of the support structure, closed by worktable 14 to form a plenum connected to a vacuum pump 16 mounted on the base structure. In the conventional manner, a vacuum applied to such plenum and the intersticies of the worktable by pump 16 functions to releaseably adhere a workpiece loaded on the worktable, in the conventional manner. Also provided on the worktable is a set of stop devices for positioning a workpiece on the worktable in a precise location.

Gantry 15 is of a conventional, inverted u-shaped configuration including a transverse portion and set of spaced depending leg portions cooperative with an elongated rack or threaded member, driven by a servomotor longitudinally or along an x-axis. Supported on the transverse portion of the gantry is a carriage 17 connected to a rack or threaded member and driven by a servomotor 18 transverserly or along a y-axis. Similarly supported on carriage 17 is a tool holder 19 connected to a rack and driven by a servomotor 20 vertically along a z-axis. Also provided on the base structure is a set of tools 21 insertable in tool holder 19.

Control computer 12 is dedicated to the displacement, of a tool inserted in tool holder 19, along x, y and z-axes, to machine the components of selected product designs pursuant to a program imputed into the computer and prospective instructions inputted by a system operator by means of a control screen. It is programmed to store data relevant to the geometrical configuration of at least one and preferably a number of product designs and the components thereof, display on command a selected one of such product designs, inquire relative to a verification or modification of a selected product design, revise the general configuration of the selected product design and the corresponding components thereof responsive to any inputted modification thereof, nest the components of the selected product design in final form in an area of a selected workpiece to be loaded on the worktable of the system, devise a cutting tool path for machining the nested components from the loaded workpiece and operate the servomotors of the gantry, tool carriage and tool holder upon loading a workpiece on the worktable, to guide the cutting tool along the tool path to produce the components from the loaded workpiece.

The computer further is programmed to include an algorithm functional to alter the magnitude of the size of a selected product design responsive to an inputted designation command of a system operator, and an algorithm functional to alter the geometric configuralion of a balance of the components of a selected product design upon selection and reconfiguralion of a selected component of such a selected product design.

In addition, the program of the control computer is functional to transfer a mounted cutting tool to a change-over station on the support structure, for a tool change responsive to a generated signal, and monitor the longevity of a tool and transfer the tool to such change-over station accessible to a system operator responsive to a signal for replacement.

Control for operation of the system is provided by a display device 23 provided with a touch screen accessible to a system operator. The device is functional upon operation of the system to display selected ones of a number of product designs and the components thereof, indicate the geometrical configuralions thereof, provide for the verification or modification of a selected product design or a component thereof, designate the required configuralion of each required workpiece to be loaded on the worktable and signal the commencement of the system in forming the components of the selected product design upon verification of the proper loading of the prescribed workpiece on the worktable. Selected designs, dimensions and other designations are inputted into the system by the operator simply by touching designated areas of the display screen in the conventional manner.

In the operation of the system as described, upon start-up, the operator would operate the control screen to display the available product designs and then select a design of interest. In response, the system displays the current dimensions and thicknesses of the components of the selected design and inquires with respect to verification or modification thereof which is responded to by the operator. With such input, the system then automatically and without further input, determines the geometry and dimensions of all of the components of the selected product design, nests the components efficiently on an area commensurate with the area of the workpiece and then develops a CNC program for machining such components.

In variation to the aforementioned routine, the operator may designate an alternate size of a selected product design whereupon the system would reconfigure the components of the reconfigured selected product design, and the operator may designate an alternate size of a selected component of a selected product design whereupon the system would reconfigure the balance of the components of the reconfigured selected product design.

In the course of a machining routine, wherever a tool of a different cutting bit configuration may be required, the system would operate to interrupt such routine and transfer the mounted tool to the change-over station where the operator would attend to replacement of the tool in accordance with instructions of the system. Similarly, upon determination of the system of a predetermined usage of a tool and the requirement of a replacement thereof, the system would operate to interrupt such routing, and transfer the tool to the change-over station where the operator would attend to replacement of the tool. In each such circumstance, the system would make the determination of a tool change, transfer the tool to the change-over station and alert the operator of the required tool change.

The system as described particularly is useful in the woodworking industry in the manufacture of various forms of furniture such as cabinets, dressers, bookcases and the like, typically requiring the machining and assembling of variously configured panels. It further provides for a system functional to produce large quantities of a variety of product designs expeditiously and economically. As indicated in the flow diagram of FIG. 1, the routine of the system merely involves the selection and optimally resizing of the available product designs and components thereof, verification of the thicknesses of the workpieces being used, loading the workpieces a selected product design on the worktable of the system and initiating the operation of the system.

A further significant and greatly beneficial aspect of the system is that it can be operated by personnel without significant technical capability, experience or skill. An operator needs only be proficient in attending to a prescribed routine, responding to system inquires, loading prescribed workpieces on the worktable of the system, attending to tool changes and initially and subsequently, as required, operating the system.

From the foregoing detailed description, it will be evident that there are a number of changes, adaptations and modifications of the present invention, which come within the province of those persons having ordinary skill in the art to which the aforementioned invention pertains. However, it is intended that all such variations not departing from the spirit of the invention be considered as within the scope thereof as limited solely by the appended claims.

1. A system for forming the components of at least one product design, comprising:
a base structure;
a worktable disposed on said base structure;
means mounted on said base structure, driven by servomotors for displacing a cutting tool in machining contact with a workpiece disposed on said worktable, along x, y and z axes; and
a control computer disposed integrally with said structure, programmed to store data relevant to the geometrical configurations of at least one product design and the components thereof, display on command a selected one of said product designs, elicit verification or modification of said selected product design, revise the geometric configuration of said selected product design and the corresponding components thereof upon any inputted modifications command, nest the components of said product design in final form, in an area of a selected workpiece, devise a cutting tool path for producing said nested components from said selected workpiece positioned on said worktable and operate said servomotors to guide said tool along said tool path to produce said components from said workpiece positioned on said worktable.

2. The system of claim 1 wherein the program of said control computer includes an algorithm functional to alter the magnitude of size of a selected product design responsive to an inputted designation command of a system operator.

3. The system of claim 1 wherein the program of said control computer includes an algorithm functional to alter the geometric configurations of a balance of the components of a selected product design upon selection and reconfiguration of a selected component of said selected product design.

4. The system of claim 1 including a control screen operative to display a video indicating the manner required to produce components of a selected product design.

5. A system according to claim 1 wherein said product design comprises a furniture design of one of a group including cabinet, dresser and bookcase designs.

6. A system according to claim 1 wherein said components include panels provided with various perimeter dimensions and thickness.

7. A system according to claim 1 wherein said support structure includes a recess closed by a porous worktable forming a plenum, and a vacuum pump operative to provide a negative pressure to said plenum and through said worktable to selectively adhere said workpiece on said worktable.

8. A system according to claim 1 including stop devices mounted on said support structure for positioning said workpiece at a selected position on said workpiece.

9. A system according to claim 1 including a gantry supported on said base structure displaceable along said x-axis by at least one screw supported on said support structure and threaded into an aligned threaded opening in said gantry, driven by one of said servomotors.

10. A system according to claim 1 including a tool holder carriage supported on said gantry displaceable along said y-axis by at least one screw supported on said gantry and threaded in said tool holder carriage, driven by one of said servomotors, positioning said workpiece at a selected position relative to said workpiece.

11. A system according to claim 1 including a gantry supported on said support structure, displaceable along said x-axis by at least one screw supported on said base structure and threaded into said gantry, driven by one of said servomotors; a carriage supported on said gantry displaceable along said y-axis by at least one screw supported on said gantry and threaded into said carriage, driven by at least one of said servomotors and a tool holder supported on said carriage displaceable along said z-axis by at least one screw supported on said carriage and threaded into said holder, driven by one of said servomotors.

12. The system of claim 1 wherein said control computer includes means for selectively displaying representations of said product designs and the dimensions of the components thereof, and means for verifying or modifying represented product designs and/or components thereof.

13. The system of claim 12 wherein said means for selectively displaying representations of said product designs and the components thereof includes a touch screen accessible to a system operator for verifying or modifying represented product designs and/or the components thereof.

14. The system of claim 12 wherein upon verification or modification of a selected product design and/or components thereof, said control computer is functional to devise the geometrical configurations and corresponding dimensions of the components of the selected product design.

15. The system of claim 1 wherein said control system is functional to communicate to an operator of said system, the actions required by said operator in the selection of a product design, the verification or modification of the geometrical configurations of the selected product design, the loading of a suitable workpiece on said worktable and the operation of said servomotors in guiding said cutting tool along a path in forming said selected components from said loaded workpiece.

16. The system of claim 1 wherein said control computer is functional to commence operation of said servomotors for machining a workpiece subject to a workpiece having been loaded on said worktable, said workpiece having been suitably positioned on said worktable and said vacuum pump having been activated for said workpiece to be suitably retained in a suitable position.

17. The system of claim 1 wherein said system includes means for displaying textual instructions to an operation of said system.

18. The system of claim 1 wherein said system includes means for displaying a video instructing in terms of operating said system to produce the components of a selected product design.

19. The system of claim 1 wherein said system includes a number of tools provided with different cutting bit configurations for producing various incisions in said workpieces, and said control computer is functional to designate a selected one of said tools to effect a required incision in a workpiece consistent with a prescribed cutting pattern.

20. The system of claim 1 wherein said control computer is functional responsive to a program requirement to operate said servomotors to displace said tool holder to a change-over station provided on said worktable.

21. The system of claim 1 wherein said control computer is functional to displace said tool holder to a change-over station upon requirement of a different tool bit configuration.

22. The system of claim 21 wherein said control computer is functional to communicate such tool change requirement to said operator and further identify the required tool replacement.

23. The system of claim 1 wherein said control computer is functional to monitor the extend of usage of each of said tools, signal a predetermined amount of usage of said tool and displace said tool to a change-over station upon determination of said usage for replacement by said operator.

24. The system of claim 1 wherein each tool of said system includes a mark around a circumference thereof indicating the approximate depth to which said tool should be inserted into a tool holder.
